(19) United States
(12) Patent Application Publication
(10) Pub. No.: US 2026/0308958 A1
(43) Pub. Date: Oct. 8, 2026

(54) DEVICE FOR OPENING AND CLOSING ENTRANCE USING MAGNET

(71) Applicant: HKD Global Limited, North Point (HK)

(72) Inventor: Bum Jun PARK, Seoul (KR)

(21) Appl. No.: 19/170,033

(22) Filed: Apr. 3, 2025

(51) Int. Cl. E05C 19/16; E04H 15/58

(52) U.S. Cl. CPC E05C 19/16; E04H 15/58

(57) ABSTRACT

A device for opening and closing an entrance based on a configuration using a magnet includes: a body (10) having a door (12) provided with a vertical side portion (12) and a horizontal side portion (13); a magnetic member (20) having a plurality of segmented magnets (25) connected in a row in the vertical side portion (12) of the door (11); and a weight member (30) connected to the horizontal side portion (13) of the door (11) to cause closing. Accordingly, it is possible to improve a configuration of applying a magnetic force to the entrance of a flexible material, which is installed in a canopy, a gazebo, a tent, and the like, thereby improving operation reliability and durability.

### BACKGROUND OF THE INVENTION

### 1. Field of the Invention

The present invention relates to a device for opening and closing an entrance, and more specifically, to a device for opening and closing an entrance using a magnet to conveniently enter and exit an interior space formed of a flexible material.

### 2. Description of the Related Art

When a space is secured with flexible materials such as a canopy, a gazebo, and a tent, an entrance for users to enter and exit is also formed of flexible materials. The flexible entrance generally has an opening/closing zipper in consideration of waterproofing and windproofing properties. Using the zipper secures some convenience, but it may be inconvenient in frequent or urgent situations. As a countermeasure against the zipper, a structure using a magnetic force of magnets may be applied.

In this regard, reference may be made to related art documents such as Korean Registered Utility Model No. 0492511 and Korean Registered Utility Model No. 2058167.

According to the former, a pair of inner and outer wings are attached to both ends of a transparent window so as to face inner and outer sides thereof, a plurality of magnets are fixed to the inner and outer wings while being inserted and arranged in a longitudinal direction, a fabric around a tent entrance is inserted between the inner and outer wings, and magnets of the inner and outer wings are attached with the fabric interposed therebetween.

According to the latter, magnet insertion grooves of left and right door membranes have rod-shaped magnets, respectively, a cover capable of covering a lower end of an entrance side of each of the left and right door membranes is formed to be longer than a lower end of a tent, and a weight is provided in the vicinity of each edge of the cover.

However, according to the above-described related art documents, there is room for improvement as it is insufficient to increase operational reliability and durability.

### RELATED ART DOCUMENT

### Patent Document

Korean Registered Utility Model No. 0492511 “MAGNET DETACHABLE TPU URETHANE TENT WINDOW” (Publication date: Oct. 28, 2020.)

Korean Registered Patent No. 2058167 “TENT EQUIPPED WITH MAGNETIC OPENING/CLOSING DOOR (Publication date: Dec. 23, 2019.)

### SUMMARY OF THE INVENTION

To solve the above-described conventional problems, an object of the present invention is to provide a device for opening and closing an entrance using a magnet to improve a configuration of applying a magnetic force to an entrance of a flexible material, which is installed in a canopy, a gazebo, a tent, and the like.

To achieve the object, the present invention relates to a device for opening and closing an entrance based on a configuration using a magnet, in which the device includes: a body having a door provided with a vertical side portion and a horizontal side portion; a magnetic member having a plurality of segmented magnets connected in a row in the vertical side portion of the door; and a weight member connected to the horizontal side portion of the door to cause closing.

According to the detailed configuration of the present invention, the body may have an accommodation space in the vertical side portion and the horizontal side portion.

According to the detailed configuration of the present invention, the magnetic member may include soft tubes interposed between the plurality of segmented magnets to support the plurality of segmented magnets.

As a modified example of the present invention, the soft tube may include an end cap to adjust an interval between the segmented magnets.

According to the detailed configuration of the present invention, a plurality of weight members may be accommodated at a plurality of positions while being isolated from each other.

As described above, according to the present invention, it is possible to improve a configuration of applying a magnetic force to the entrance of a flexible material, which is installed in a canopy, a gazebo, a tent, and the like, thereby improving operation reliability and durability.

### BRIEF DESCRIPTION OF THE DRAWINGS

FIG. 1 is a configuration view of a state in which a device according to the present invention is applied.

FIG. 2 is a configuration view showing a magnetic member of the device according to the present invention.

FIG. 3 is a configuration view showing a weight member of the device according to the present invention.

FIG. 4A-4D are configuration views showing an operation of the device according to the present invention.

### DETAILED DESCRIPTION OF THE INVENTION

Hereinafter, the embodiments of the present invention will be described in detail with reference to accompanying drawings as follows.

The present invention relates to a device for opening and closing an entrance based on a configuration using a magnet. The present invention is directed to an entrance employed in a canopy, a gazebo, a tent, and the like, but is not necessarily limited thereto. The present invention may not be limited to the entrance, and may be applied to a window and the like.

According to the present invention, a body 10 has a door 11 formed with a vertical side portion 12 and a horizontal side portion 13.

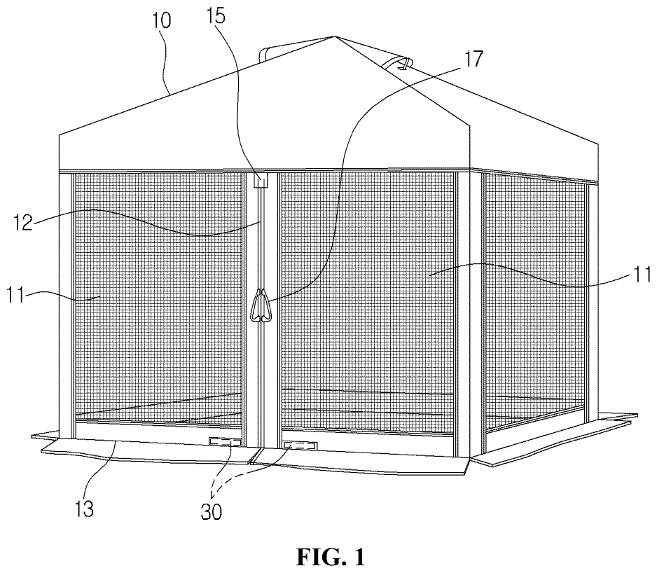

Referring to FIG. 1, a state in which the door 11 is provided on one surface of the body 10 as an entrance is shown. Generally, the door 11 is formed symmetrically left and right, but only one side thereof may be opened and closed as necessary. The vertical side portion 12 and the horizontal side portion 13 are formed on doors 11 in an “L” shape, respectively. The vertical side portion 12 and the horizontal side portion 13 of the door 11 may be formed to have higher strength than other areas. The door 11 may have a handle portion 17 at a position approximately intermediate the vertical side portion 12.

According to the detailed configuration of the present invention, the body 10 has an accommodation space in the vertical side portion 12 and the horizontal side portion 13.

The vertical side portion 12 and the horizontal side portion 13 cause frequent position change according to opening and closing of the door 11. The vertical side portion 12 and the horizontal side portion 13 have a space for accommodating main components to be described later. The accommodation space of the vertical side portion 12 and the horizontal side portion 13 is preferably formed by sewing. The accommodation space of the vertical side portion 12 and the horizontal side portion 13 may be divided into a plurality of spaces.

In addition, according to the present invention, the magnetic member 20 has a plurality of segmented magnets 25 connected in a row in the vertical side portion 12 of the door 11.

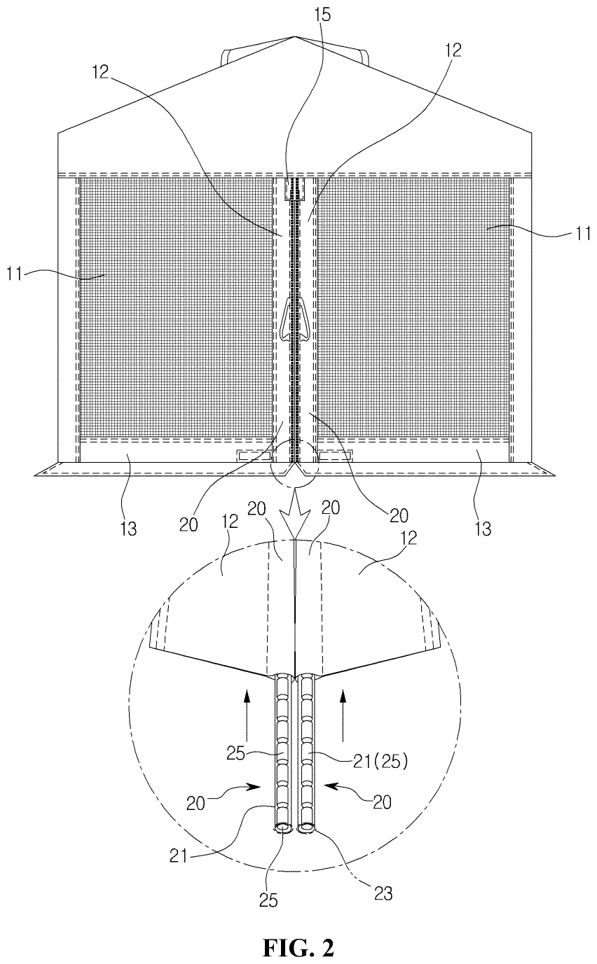

Referring to FIGS. 1 and 2, the plurality of segmented magnets 25 constituting the magnetic member 20 are accommodated in the vertical side portion 12 of the door 11. The segmented magnets 25 are connected in a row over the entire length of the vertical side portion 12. In the accommodation space of the vertical side portion 12, all of the segmented magnets 25 remain connected in a row. All the segmented magnets 25 have the same magnetic force (Gaussian), but do not exclude differential configurations. The magnetic members 20 of one door 11 and the other door 11 are symmetrically disposed in the same standard.

In this case, the segmented magnet 25 preferably has a cylindrical shape of a circular cross-section in terms of operability and durability, but the present invention is not limited thereto.

According to the detailed configuration of the present invention, the magnetic member 20 includes soft tubes 21 interposed between the plurality of segmented magnets 25 to support the plurality of segmented magnets 25.

FIG. 2 shows the soft tube 21 and the segmented magnet 25 constituting the magnetic member 20. The soft tube 21 may use a PVC hose or the like, and allows the plurality of segmented magnets 25 to be maintained in a row. When the soft tube 21 is used, it is convenient to put the segmented magnet 25 into the vertical side portion 12, and it is advantageous to constantly maintain a closing force of the door 11 by a magnetic force. However, since the magnetic force is weakened due to the soft tube 21, it is recommended to make the PVC hose thinner or to form a cut groove.

Meanwhile, a patch portion 15 reinforced with a separate fabric is formed at an upper end of the vertical side portion 12 of the door 11. The patch portion 15 closely supports the upper end of the vertical side portion 12 and an upper end of the soft tube 21 of the magnetic member 20. Even if the door 11 is frequently opened and closed, the door 11 may be buffered with the patch portion 15 to prevent durability from deteriorating.

As a modified example of the present invention, the soft tube 21 may further include an end cap 23 to adjust an interval between the segmented magnets 25.

FIG. 2 shows a state in which the end cap 23 is mounted on a lower end of the soft tube 21 accommodating the segmented magnets 25. The end cap 23 prevents the segmented magnets 25 from being randomly separated from the upper and lower ends of the soft tube 21. Moreover, the end cap 23 may be applied to change an adhesive force (interval) to the segmented magnets 25 at the lower end of the soft tube 21. The change of adhesive force by the end cap 23 causes a change in elasticity of the vertical side portion 12.

In addition, according to the present invention, the weight member 30 is connected to the horizontal side portion 13 of the door 11 to cause closing.

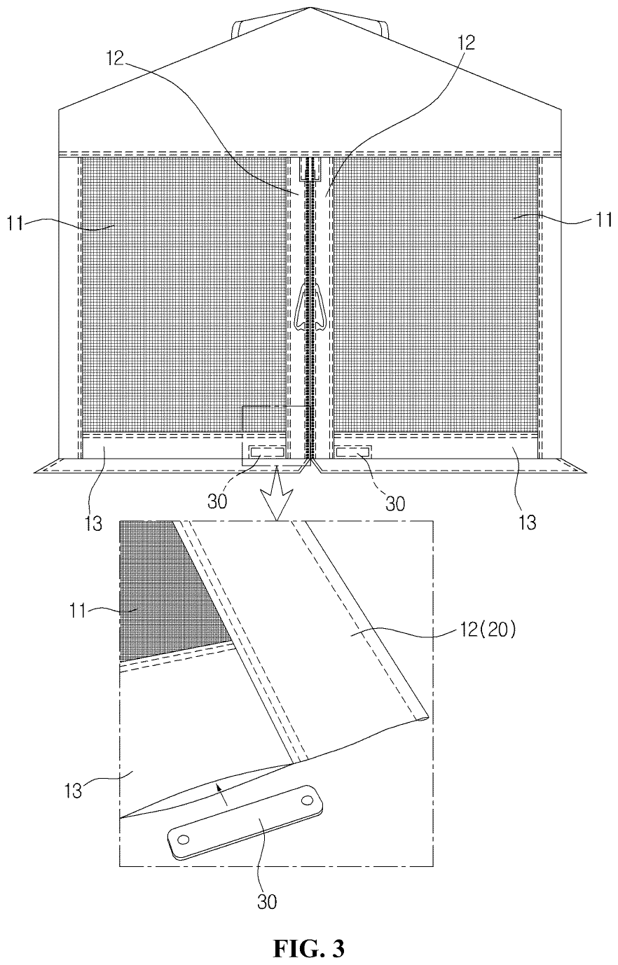

Referring to FIGS. 1 and 3, the weight member 30 is provided on the horizontal side portion 13 of one door 11 and the other door 11. The weight member 30 is disposed at a part closest to the horizontal side portion 13 of the doors 11 facing each other. The weight member 30 is preferably formed of a metal material having a high specific gravity, but the present invention is not limited thereto. When the weight member 30 is a metal material, the weight member 30 may be formed by insert molding using a resin material to prevent rust.

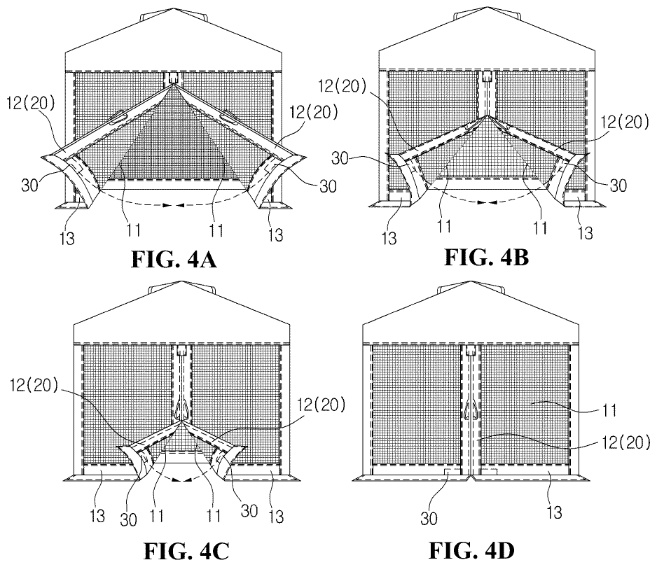

Referring to FIGS. 4A-4D, a process in which the door 11 of the body 10 is closed while being fully opened is shown. In FIG. 4A, the upper end of the vertical side portion 12 is opened to the patch portion 15 due to full opening of the door 11. In FIG. 4B, as the weight member 30 falls under its own weight, the upper end of the magnetic member 20 is sucked so that the door 11 is slightly closed. In FIG. 4C, as the weight member 30 further falls, the door 11 is further closed. In FIG. 4D, as the weight member 30 falls maximally, all the magnetic members 20 are sucked so that the door 11 is fully opened. Thereafter, the door 11 may be opened immediately depending on a magnitude of an external force pushing the door 11.

By adjusting elasticity using the end cap 23 mounted on the soft tube 21 of FIG. 2, a posture of opening and closing the door 11 may be changed.

According to the detailed configuration of the present invention, a plurality of weight members 30 are accommodated at a plurality of positions while being isolated from each other.

In FIG. 3, the plurality of weight members 30 may be separately accommodated in each door 11. An independent accommodation space is formed in the horizontal side portion 13 of the door 11, and the weight member 30 is put therein and sewed. When the plurality of weight members 30 are distributed on the horizontal side portion 13, a speed of the closing operation is increased. The plurality of distributed weight members 30 may be formed and disposed in different sizes and shapes.

The present invention is not limited to the disclosed embodiments, and it is obvious to those skilled in the art that the present invention may be variously modified and changed without departing from the spirit and scope of the present invention. Therefore, such variations or modifications should fall within the scope of the claims of the present invention.

What is claimed is:

1. A device for opening and closing an entrance based on a configuration using a magnet, the device comprising:
a body (10) having a door (12) provided with a vertical side portion (12) and a horizontal side portion (13);
a magnetic member (20) having a plurality of segmented magnets (25) connected in a row in the vertical side portion (12) of the door (11); and
a weight member (30) connected to the horizontal side portion (13) of the door (11) to cause closing.

2. The device of claim 1, wherein the body (10) has an accommodation space in the vertical side portion (12) and the horizontal side portion (13).

3. The device of claim 1, wherein the magnetic member (20) includes soft tubes (21) interposed between the plurality of segmented magnets (25) to support the plurality of segmented magnets (25).

4. The device of claim 3, wherein the soft tube (21) includes an end cap (23) to adjust an interval between the segmented magnets (25).

5. The device of claim 1, wherein a plurality of weight members (30) are accommodated at a plurality of positions while being isolated from each other.
